(19) United States
(12) Patent Application Publication
(10) Pub. No.: US 2026/0251100 A1
(43) Pub. Date: Aug. 27, 2026

(54) DETERMINATION OF THE DIRECTION OF ROTATION OF A CRANKSHAFT FROM A SIGNAL GENERATED BY A MAGNETIC CRANKSHAFT SENSOR

(71) Applicant: SCHAEFFLER TECHNOLOGIES AG & CO. KG, Herzogenaurach (DE)

(72) Inventors: Fabien JOSEPH, CASTANET TOLOSAN (FR); Stéphane ELOY, Tournefeuille (FR)

(73) Assignee: SCHAEFFLER TECHNOLOGIES AG & CO. KG, Herzogenaurach (DE)

(21) Appl. No.: 19/398,215

(22) Filed: Nov. 24, 2025

(30) Foreign Application Priority Data
Nov. 28, 2024 (FR) FR2413102

(51) Int. Cl. F02D 41/00

(52) U.S. Cl. CPC F02D 41/009; F02D 41/0097; F02D 2250/06

(57) ABSTRACT

The method describes a method for determining the direction of rotation of a crankshaft driving a camshaft in an internal combustion engine with at least four cylinders, using one magnetic sensor for the crankshaft and another for the camshaft. The crankshaft sensor detects the passage of the teeth of a target mounted on the crankshaft, while the camshaft sensor detects the teeth of its target. The method begins with a calibration to determine a reference angular difference. Then, when a camshaft edge-front is detected, a check is made to determine whether a local minimum of crankshaft speed is observed. If it is, two angular distances are calculated between the camshaft edge-fronts and the speed minimum so as to compare these with the angular difference, thereby enabling the direction of rotation of the crankshaft to be determined.

### CROSS REFERENCE TO RELATED APPLICATIONS

This application claims priority to French Application No. FR2413102, filed Nov. 28, 2024, the contents of such application being incorporated by reference herein.

### FIELD OF THE INVENTION

The present invention relates to the field of sensor systems in internal combustion engines, and more particularly to a method and a device for detecting the direction of rotation of a crankshaft from a signal generated by a magnetic crankshaft sensor. The invention finds particular application in heavy vehicles and generators, where precise detection of the direction of rotation is crucial for the proper functioning and safety of the engine.

### BACKGROUND OF THE INVENTION

The cycle of an internal combustion engine includes several phases, which are staggered over time for each cylinder, with the synchronized control of the valves of the combustion engine being achieved by the camshaft.

In order for the combustion cycle to proceed normally, a reliable angular reference needs to be available that is used as the basis for determining each phase of each cylinder.

The camshaft is set into rotation by the crankshaft. The crankshaft is a mechanical device that allows, by means of a connecting rod, the rectilinear movement of a piston to be converted into a continuous rotational movement, and vice versa, thus converting the energy of combustion of the fuel in the cylinders into mechanical energy.

Thus, knowing the angular position of the crankshaft provides a reliable angular reference that is used as the basis for determining each phase of each cylinder.

Such a reference is available via a toothed wheel, also called target, that is rotationally integral with the crankshaft. The wheel is associated with a dedicated sensor, called crankshaft sensor, the ultimate purpose of which is to allow the angular position and the rotation speed of the toothed wheel to be determined. The sensor is equipped with a sensitive element. According to one example, the wheel is metal and the sensitive element, such as an inductive sensor, is able to detect metal. The profile of the wheel typically includes a target provided with markings distributed around its periphery. The function of the crankshaft sensor is to convert the measured magnetic field into an electrical signal and thus provide a voltage-potential signal on two wires connected to it. The crankshaft sensor is typically mounted in the vicinity of the engine flywheel, which acts as a rotating target or supports such a target.

The rotating target has a signature, also called long tooth or gap, formed by a singularity in the profile (which is otherwise even) that usually corresponds to two missing markers, and that allows a reference to be defined for the position of the crankshaft. Such a signature generates a different signal from the other markers, for determining when the rotating target has made a complete rotation.

A commonly employed rotating target comprises 60 markers distributed over the periphery of the rotating target, and two consecutive markers that are removed to create the signature. Such a target is called a 60-2 rotating target. Another known rotating target is the 36-2 rotating target (34 markers plus two missing markers).

Magnetic type crankshaft sensors are commonly used because of their simplicity and robustness.

The rotation of the rotating target causes periodic modifications in the magnetic flux that are due to the passage of the markers, these modifications being converted by the sensor into voltage variations that then can be sent to the engine management computer by means of electric wires. The voltage variations include rising edges and falling edges forming a periodic signal that is synchronized with the passage of the markers past the sensor.

However, these sensors do not inherently offer the ability to detect the direction of rotation of the engine.

It is known practice to attempt to determine the direction of rotation of the crankshaft by observing a sequence comprising an acquisition of a sequence of signal edge-fronts generated by the magnetic crankshaft sensor and determining the passage of the signature.

However, it is thus necessary to wait for a complete revolution of the crankshaft, i.e. 360 degrees CRK, in order to ensure that the signature passes.

During this rotation through 360° CRK, half a camshaft revolution will have taken place, and two (for a 4 cylinder) or three (for a 6 cylinder engine) intake/compression/combustion/exhaust phases in the various cylinders will have taken place.

### SUMMARY OF THE INVENTION

One aspect of the invention is a method for detecting the direction of rotation of a crankshaft of an internal combustion engine by means of a magnetic sensor of the angular position of the crankshaft.

One aspect of the invention is achieved using a method for determining a direction of rotation of a crankshaft driving a camshaft of an internal combustion engine equipped with at least 4 cylinders by means of a magnetic crankshaft sensor and of a camshaft sensor, the camshaft sensor being configured to generate a camshaft signal with edge-fronts, in response to detection of the passage of teeth of a camshaft target, the camshaft being mounted on, to rotate integrally with, the camshaft fitted with a camshaft target, said target having X+1 teeth, X of which are equally angularly distributed, X being a multiple of the number of cylinders. The additional tooth, called the +1 tooth, represents the asymmetry of the camshaft.

Each tooth can be considered as being an excess of material on the target or, on the contrary, a void in the material.

Advantageously, the X equally distributed teeth must not be positioned in a zone extending +/−5° CRK around the top dead center (speed minimum).

Since each tooth of the camshaft target is identical, usually only one of either the rising or falling edge-fronts is transmitted to the control unit.

According to an aspect of the invention, the crankshaft sensor is configured to generate a crankshaft signal comprising edge-fronts, in response to detection of the passage of teeth of a crankshaft target mounted on, to rotate integrally with, the crankshaft, the method comprising the following steps: an initial calibration step to determine a so-called decision angular difference, then, upon receipt of a current camshaft edge-front: determining the position representing the middle of the tooth, and if determined, store it (for later use), determining if a local minimum of crankshaft speed has occurred between the position representing the middle of the previous camshaft tooth and the current position representing the middle of the tooth, and if it has:
determining a so-called reference angular position of said crankshaft corresponding to the local speed minimum from the crankshaft signal,
determining a first angular distance (D1) between the angular position representing the middle of the previous camshaft tooth and the reference angular position,
determining a second angular distance (D2) between the reference angular position and the angular position representing the middle of the current camshaft tooth,
determining the direction of rotation of said crankshaft by comparing the first angular distance and the second angular distance with the decision angular difference.

A local speed minimum is located near a top dead center. The rise and fall of the pistons generates an acyclism of the engine.

Advantageously, the decision angular difference may be determined from angular positions of the teeth of the crankshaft target.

A second aspect of the invention proposes a module for determining a direction of rotation of a crankshaft driving a camshaft of an internal combustion engine of a vehicle equipped with at least 4 cylinders by means of a magnetic crankshaft sensor and of a camshaft sensor,
the camshaft sensor being configured to generate a camshaft signal with edge-fronts, in response to detection of the passage of teeth of a camshaft target of type X+1 mounted on, to rotate integrally with, the camshaft, said target having X+1 teeth, X of which are equally angularly distributed, X being a multiple of the number of cylinders,
the crankshaft sensor being configured to generate a crankshaft signal comprising edge-fronts, in response to detection of the passage of teeth of a crankshaft target mounted on, to rotate integrally with, the crankshaft,
the vehicle comprising a computer (UC) configured to implement the following steps:
   an initial calibration step to determine a so-called decision angular difference, then,
   on receipt of a current camshaft edge-front:
   determining if a local minimum of crankshaft speed has occurred between the previous camshaft edge-front and the current edge-front,
   if it has,
determining a so-called reference angular position of said crankshaft corresponding to the local speed minimum from the crankshaft signal,
determining a first angular distance (D1) between the angular position representing the previous camshaft edge-front and the reference angular position,
determining a second angular distance (D2) between the reference angular position and the angular position of the current camshaft edge-front,
determining the direction of rotation of said crankshaft by comparing the first angular distance and the second angular distance with the decision angular difference.

### BRIEF DESCRIPTION OF THE FIGURES

Further features and advantages of aspects of the invention will become apparent on reading the following detailed description, which will be more clearly understood with reference to the appended drawings, in which:

FIG. 1_illustrates an embodiment of a module according to the invention and of its physical environment;

FIG. 2_illustrates an embodiment of a method according to the invention;

FIG. 3_is a timing diagram of one example of a target of 12+1 type for the implementation of an aspect of the invention, and

FIG. 4 is a timing diagram of another example of a target of 6+1 type for implementing an aspect of the invention.

### DETAILED DESCRIPTION OF ASPECTS OF THE INVENTION

As the embodiments described hereinafter are entirely nonlimiting, it will in particular be possible to imagine variants of aspects of the invention that comprise only a selection of features described below, isolated from the other described features, if this selection of features is sufficient to confer a technical advantage or to differentiate the aspects of invention with respect to the prior art. This selection comprises at least one preferably functional feature without structural details, or with only part of the structural details if this part alone is sufficient to confer a technical advantage or to differentiate the aspects of invention with respect to the prior art.

With reference to FIG. 1 there is now described one embodiment of a method P for determining a direction of rotation of a crankshaft A driving a camshaft of an internal combustion engine equipped with at least 4 cylinders by means of a magnetic crankshaft sensor and of a camshaft sensor, and also of a module M implementing the method.

The camshaft sensor is configured to generate a camshaft signal with edge-fronts, in response to detection of the passage of teeth of a camshaft target of type X+1 mounted on, to rotate integrally with, the camshaft, said target having X+1 teeth, X of which are equally angularly distributed, X being a multiple of the number of cylinders.

The crankshaft sensor is configured to generate a crankshaft signal comprising edge-fronts, in response to detection of the passage of teeth of a crankshaft target mounted on, to rotate integrally with, the camshaft.

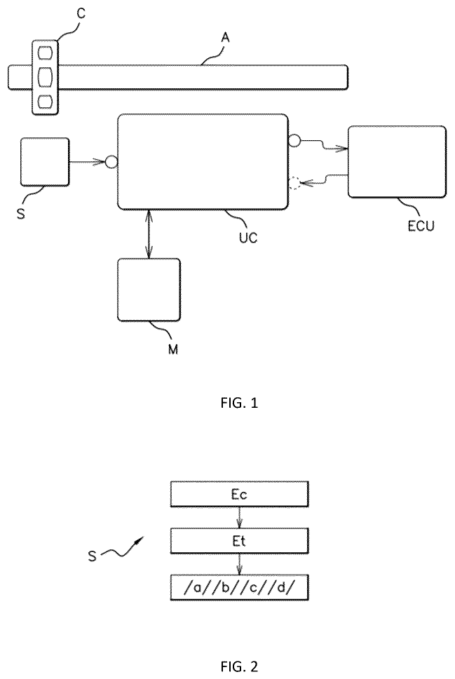

Referring to FIG. 2, method P according to an aspect of_the invention comprises an initial calibration step Ec to determine an angular difference called a decision difference.

The method P further comprises, upon receipt of a current camshaft edge-front, a step Et of determining whether a local minimum of crankshaft speed has occurred between the preceding camshaft edge-front and the current edge-front.

If it has, the method comprises the following steps:
determining the position representing the middle of the tooth, and if determined, storing this position,
/a/ determining a so-called reference angular position of said crankshaft corresponding to the local speed minimum from the crankshaft signal,
/b/ determining a first angular distance (D1) between the angular position representing the middle of the previous camshaft tooth and the reference angular position,
/c/ determining a second angular distance (D2) between the reference angular position and the angular position representing the middle of the current camshaft tooth,
/d/ determining the direction of rotation of said crankshaft by comparing the first angular distance and the second angular distance with the decision angular difference.

Determining a reference angular position of the crankshaft corresponding to a local speed minimum is known to those skilled in the art and the reader may advantageously refer to publication WO2002045080, incorporated herein by reference.

This determination consists in generating a speed curve in the vicinity of the combustion-stroke top dead centers for each of the cylinders and approximating this curve to a parabola obtained by the mathematical method of least squares. Knowing the minimum of the parabola corresponding to the speed minimum of the crankshaft, the angular position of the crankshaft corresponding to the speed minimum is then determined.

The decision angular difference may for example be determined from angular positions of the teeth of the crankshaft target. The angular differences between the angular positions representing the middles of the camshaft target teeth flanking the position representing the speed minimum are thus evaluated for all speed minima occurring during an engine cycle of 720° CRK (there will be as many of these as the engine has cylinders).

The initial calibration step may, for example, comprise a step of measuring a first angular distance between a middle of a tooth of the camshaft target and a speed minimum, and then a second angular distance between the speed minimum and the middle of a following tooth of the camshaft target, in the direction of forward rotation of the engine.

### 12+1 Target

In the context of a 12+1 target associated with 6 cylinders, it is possible, for example, to measure a first angular distance equal to 23° and a second angular distance equal to 37°.

In other words, the angular distance measured between the position of the speed minimum and the position of the middle of the previous camshaft-target tooth measures 23°, while the angular distance between the position of the speed minimum and the position of the middle of the following camshaft-target tooth measures 37°.

Given the symmetry of the camshaft target, and the multiplicity of the number of edge-fronts in relation to the number of cylinders, this profile is repeated. By averaging the two angular distances, it is possible to decide on an angular difference referred to as the decision difference that is equal to 30°.

During step /d/, when the angular distance D1 is less than 30°, it is therefore inferred that the engine is rotating in a forward direction, whereas when the angular distance D2 is greater than 30°, it may be deduced that the engine is rotating backward.

### 6+1 Target

In the context of a 6+1 target associated with 6 cylinders, it is possible, for example, to measure a first angular distance equal to 80° and a second angular distance equal to 40° for the middles of teeth evenly distributed on the target. In the case of the additional edge-front, it is possible, for example, to measure a first angular distance equal to 50° and a second angular distance equal to 40°.

By averaging the two closest angular distances, it is possible to decide on an angular difference referred to as the decision difference that is equal to 45°.

During step /d/, when the angular distance D1 is greater than 45°, it is therefore inferred that the engine is rotating in a forward direction, whereas when the angular distance D2 is less than 45°, it may be deduced that the engine is rotating backward.

### More Generally

The determinant, the so-called decision angular difference, can be determined from the timing diagram of the engine representing the teeth of the crankshaft and camshaft targets as a function of the absolute position of the crankshaft.

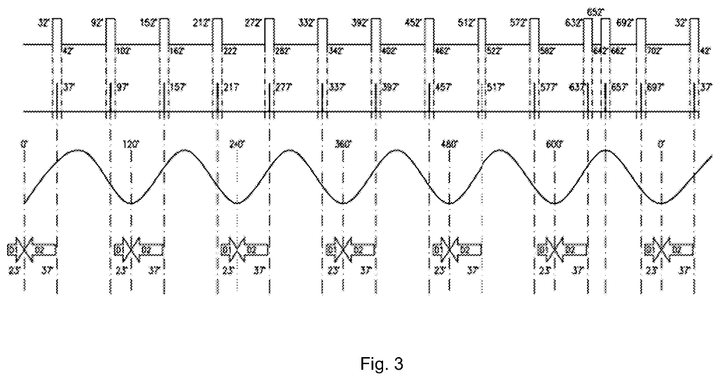

For example, FIG. 3 illustrates the theoretical timing diagram for the 12+1 target. A first line illustrates the angular evolution of a signal generated by the crankshaft sensor between 0 and 720° CRK, a third line illustrates the angular evolution of a signal generated by the camshaft sensor and a second line illustrates events generated by the control unit.

As can be read off FIG. 3, the angular positions of the teeth of the camshaft target are: 32°, 42°, 92°, 102°, 152°, 162°, 212°, 222°, 272°, 282°, 332°, 342° 392°, 402°, 452°, 462°, 512°, 522°, 572°, 582°, 632°, 642°, 652°, 662°, and 692°, 702°.

Each tooth thus measures 10°, and each tooth middle has an angular position close to 37°, 97°, 157°, 217°, 277°, 337°, 397°, 457°, 517°, 577°, 637°, 657°, 697°.

In such a target, by construction, the first top dead center, i.e. the first speed minimum, is expected between angles 97° and 157° at the 120° position, between angles 217° and 277° at the 240° position, between angles 337° and 397° at the 360° position, between angles 457° and 517° at the 480° position, between angles 577° and 637° at the 600° position, and between angles 697° and 37° at the 0-degrees position.

It is therefore determined that there is a theoretical difference of 23° between a camshaft-target angular position preceding a speed minimum and the speed minimum itself, and a theoretical angular difference of 37° between the speed minimum and the camshaft-target angular position succeeding the speed minimum.

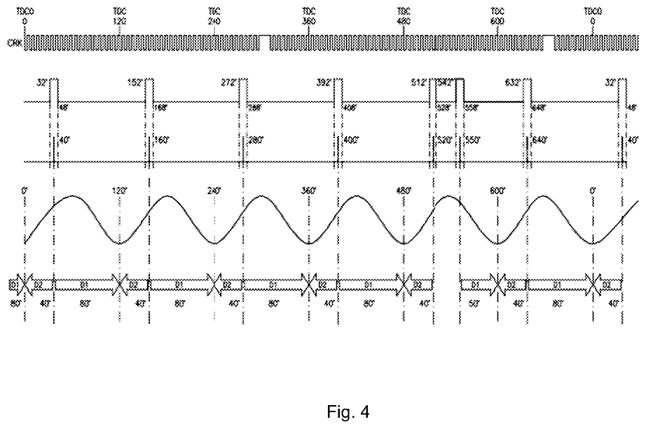

Like with the measurements described above, by averaging the two angular distances, it is possible to decide on an angular difference referred to as the decision difference that is equal to 30° from the theoretical knowledge of the timing diagram for the target. According to another example, FIG. 4 illustrates the theoretical timing diagram for the 6+1 target. A first line illustrates the angular evolution of a signal generated by the crankshaft sensor between 0 and 720° CRK, a third line illustrates the angular evolution of a signal generated by the camshaft sensor and a second line illustrates events generated by the control unit.

As can be read off FIG. 3, the angular positions of the camshaft target teeth are 32°, 48°, 152°, 168°, 272°, 288°, 392°, 408°, 512°, 528°, 542°, 558°, 632°, 648°. The angular positions of the middles of the teeth are then 40°, 160°, 280°, 400°, 520°, 550°, 660°.

In such a target, by construction, the first top dead center, i.e. the first speed minimum, is expected between angles 40° and 160° at the 120° position, between angles 160° and 280° at the 240° position, between angles 280° and 400° at the 360-degrees position, between angles 400° and 520° at the 480-degrees position, between angles 550° and 660° at the 600-degrees position, and between angles 660° and 40° at the 0-degrees position.

It is therefore determined that there is a theoretical difference of 50° between an angular position representing the middle of the camshaft target tooth preceding a speed minimum and the speed minimum itself, this being the minimum of the possible differences 80° and 50°, and a theoretical angular difference of 40° between the speed minimum and the angular position representing the middle of the camshaft target tooth succeeding the speed minimum.

Like with the measurements described above, by averaging the two angular distances, it is possible to decide on an angular difference referred to as the decision difference that is equal to 45° from the theoretical knowledge of the timing diagram for the target.

It may be noted that a speed minimum, corresponding to top dead center number 5, occurs at the 480° angular position, between the 400° angular position and the 520° angular position. Two theoretical differences, respectively 80° and 40° between the speed-minimum angular position and the two flanking target angular positions, are determined.

It may also be noted that a speed minimum, corresponding to top dead center number 6, occurs at the 600° angular position, between the 550° angular position and the 640° angular position. Two theoretical differences, respectively 50° and 40° between the speed-minimum angular position and the two flanking target angular positions, are determined.

Also, the choice of 50° as the reference difference is still suitable for the passing of a +1 tooth.

Reading the timing diagram, from left to right, thus shows how the edge-fronts vary, with respect to time, when the motor is rotating in a direction called the forward direction.

Of course, when the motor is rotating in a direction called the backward direction, opposite to the forward direction, the variation in edge-fronts, with respect to time, can be discovered by reading the timing diagram from right to left.

Also, for example for the 12+1 target, measuring a first angular difference of less than 30° between an angular position of a camshaft target and a speed minimum can be used to deduce that the engine is rotating in a forward direction, whereas if the first angular difference is greater than 30°, it is determined that the engine is rotating in reverse.

Also, for example for the 6+1 target, measuring a first angular difference of more than 45° between an angular position of a camshaft target and a speed minimum can be used to deduce that the engine is rotating in a forward direction, whereas if the first angular difference is greater than 45°, it is determined that the engine is rotating in reverse.

Of course, the invention is not limited to the examples that have just been described, and numerous modifications can be made to these examples without departing from the scope of the invention. Furthermore, the various features, forms, variants and embodiments of the invention can be combined with one another in various combinations provided they are not incompatible or mutually exclusive.

1. A method for determining a direction of rotation of a crankshaft driving a camshaft of an internal combustion engine equipped with at least 4 cylinders by a magnetic crankshaft sensor and of a camshaft sensor, the camshaft sensor being of the inductive type and configured to generate a camshaft signal with edge-fronts, in response to detection of the passage of teeth of a camshaft target of type X+1 mounted on, to rotate integrally with, the camshaft, said target having X+1 teeth, X of which are equally angularly distributed, X being a multiple of the number of cylinders,
the crankshaft sensor being configured to generate a crankshaft signal comprising edge-fronts, in response to detection of the passage of teeth of a crankshaft target mounted on, to rotate integrally with, the crankshaft,
the method comprising:
an initial calibration step to determine a so-called decision angular difference, then,
on receipt of a current camshaft edge-front:
determining the position representing the middle of the tooth, and if determined, storing this position,
determining if a local minimum of crankshaft speed has occurred between the position representing the middle of the previous camshaft tooth and the position representing the middle of the current camshaft tooth,
if it has,
determining a so-called reference angular position of said crankshaft corresponding to the local speed minimum from the crankshaft signal,
determining a first angular distance between the angular position representing the middle of the previous camshaft tooth and the reference angular position,
determining a second angular distance between the reference angular position and the angular position representing the middle of the current camshaft tooth,
determining the direction of rotation of said crankshaft by comparing the first angular distance and the second angular distance with the decision angular difference.

2. The method as claimed in claim 1, wherein the decision angular difference is determined from angular positions of the teeth of the crankshaft target.

3. A module for determining a direction of rotation of a crankshaft driving a camshaft of an internal combustion engine of a vehicle equipped with at least 4 cylinders by a magnetic crankshaft sensor and of a camshaft sensor,
the camshaft sensor being configured to generate a camshaft signal with edge-fronts, in response to detection of the passage of teeth of a camshaft target of type X+1 mounted on, to rotate integrally with, the camshaft, said target having X+1 teeth, X of which are equally angularly distributed, X being a multiple of the number of cylinders,
the crankshaft sensor being configured to generate a camshaft signal comprising edge-fronts, in response to detection of the passage of teeth of a crankshaft target mounted on, to rotate integrally with, the crankshaft,
the vehicle comprising a computer configured to implement the following steps:
an initial calibration step to determine a so-called decision angular difference, then,
on receipt of a current camshaft edge-front:
determining if a local minimum of crankshaft speed has occurred between the previous camshaft edge-front and the current edge-front,
if it has,
determining a so-called reference angular position of said crankshaft corresponding to the local speed minimum from the crankshaft signal,
determining a first angular distance between the angular position representing the previous camshaft edge-front and the reference angular position,
determining a second angular distance between the reference angular position and the angular position of the current camshaft edge-front,
determining the direction of rotation of said crankshaft by comparing the first angular distance and the second angular distance with the decision angular difference.
